(19) United States
(12) Patent Application Publication
(10) Pub. No.: US 2001/0003440 A1
(43) Pub. Date: Jun. 14, 2001

(54) METHOD OF SIGNALLING TRAFFIC-RELEVANT STATUS INFORMATION

(76) Inventor: MICHAEL WILHELM, VAIHINGEN/ENZ-KLEINGLATTBACH (DE)

Correspondence Address: SUGHRUE MION ZINN MACPEAK & SEAS PLLC, 2100 PENNSYLVANIA AVENUE NW, WASHINGTON, DC, 200373213

(21) Appl. No.: 09/413,373

(22) Filed: Oct. 6, 1999

(30) Foreign Application Priority Data
Oct. 7, 1998 (DE) 19846169.0

(51) Int. Cl. G08G 1/00

(52) U.S. Cl. 340/905; 340/901; 340/902; 340/904; 340/906

(57) ABSTRACT

The invention relates to a method of signalling traffic-relevant status information (5), in particular warning signals, to road users. In order to convey warning signals in a simple and reliable manner to road users when these are distracted by terminal equipment, it is provided that the terminal equipment, in particular mobile telephone, audio device, computer, is used for acoustic and/or optical and/or mechanical signalling, during which time the normal function of the terminal is suppressed.

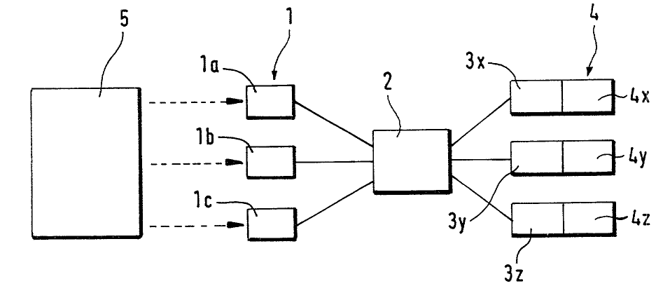

The invention relates to a method of signalling traffic-relevant status information according to the preamble of claim 1.

The continuous increase in road traffic calls for a high degree of concentration and attention on the part both of motorised road users and pedestrians. Any distraction, for example the use of a mobile telephone or an audio device at high volume, represents a potential source of danger. Studies have shown that driving errors during telephoning—using a “handy” or hands-free system—are multiplying. Therefore some countries, for example Spain, Portugal, Italy and Switzerland, have imposed a general ban on the use of telephones during car driving. The publication “Sonntag Aktuell” of Dec. 14, 1997 states that this subject is also being discussed in Germany.

The object of the invention is to signal traffic-relevant status information, in particular warning signals, in a simple and reliable manner to road users when these are distracted by electronic equipment, in particular a mobile telephone, audio device or on-board computer.

In accordance with the invention, this object is achieved by the characterising features of claim 1. It is provided that the terminals are, as it were, functionally converted in order to signal warning signals to the road user by means of existing assemblies. Inasmuch as the normal function of the terminal is suppressed during a danger situation, this in itself constitutes a signal leading to increased attention on the part of the road user. However, acoustic and/or optical and/or mechanical signalling is also to be understood as an additional warning- display or announcement or a vibration alarm. What is important is imply that the vehicle driver or pedestrian is startled in some way. The traffic-relevant status information to be signalled consists primarily of vital warning signals, such as for example police- or fire-brigade sirens, vehicle flashing hazard signals, flashing police-car lights, illuminated road-works or traffic lights. Also conceivable is the vehicle-internal signalling of environmental status information, such as current pollutant levels, temperature and so on, also status information relating to the vehicle, such as for example vehicle noises from the wheel bearings, engine noises, excessive engine speed, low fuel or excessive coolant temperature, as well as status information relating to body functions, such as for example heart frequency.

A system for the implementation of the method is characterised by the features of claim 2. Essentially three serially connected assemblies are provided, namely means for recording the status information, a processing—and control unit, and means for acting upon the terminal. Such a system easily enables the terminal to be acted upon by the pre-processed status information, the normal function of the terminal in each case being suppressed by—in the sense of being entirely replaced or partially superimposed by—the pre-processed signals.

In accordance with an advantageous further development of the invention characterised in claim 3, in addition to the system components, transmission means are provided by which the status information can be forwarded not only to the terminal but also to a central station. If the terminal is a mobile telephone, the mobile telephone cellular network can be used for this purpose. Status information of interest not only to the road user comprises in particular environmental data, such as instantaneous atmospheric pollutant levels, atmospheric pressure, temperature. These data could be transmitted automatically to a weather service with each telephone call. It would also be conceivable for the status information relating to the body function to be transmitted to the family doctor. A preferred embodiment consists in that the central station calls up the data of interest. This activity could be indicated to the road user, possibly in association with a charge credit or access to the central station data.

In accordance with claim 4, the means for recording the status information are preferably known sensors. In addition to the sensors which record vehicle-external status information, sensors for vehicle-internal status information can also be provided. This relates in particular to engine function signals. For example, vehicle noises or engine noises to be evaluated as evidence of deficient vehicle operating reliability, could be indicated by interrupting the sound reproduction of an audio device or mobile telephone.

In accordance with claim 5, in addition to input-end interfaces and/or signal converters as well as signal processing means, the processing- and control unit can also comprise storage means and/or selection means. On the basis of threshold value criteria, the selection means facilitate a decision as to which sensorially determined status information is forwarded to the terminal. Selection means can also support a priority control function, the activation of additional signalling means, or a type of driving behaviour tutorial function. Optionally provided storage means can additionally be useful for this purpose.

In accordance with claim 6, the loudspeakers, displays or vibration elements provided in the respective terminals serve to act upon the terminal. These assemblies, in particular a vibration element, can of course also be additionally provided for this purpose.

Additionally, in accordance with claim 7, the terminals can be designed such that information is transmitted back, as it were, to the processing- and control device. This could for example consist of the information as to which device is currently in use.

In the case of a mobile telephone, in accordance with claim 8, an automatic announcement to the subscriber could additionally be activated.

In the following the invention will be described in detail in the form of an exemplary embodiment illustrated in the Figure.

A system for signalling traffic-relevant status information 5 to road users substantially comprises means 1 for recording status information, a processing- and control unit 2, and means 4 for acting upon a terminal. The means 1 for recording the status information 5 consist either of a vehicle-internal or vehicle-external microphone 1a, an engine sensor 1b, or another sensor 1c. These recording means 1 serve to pick up warning signals, for example from a police- and/or fire-brigade siren, road-works flashing warning lights, traffic lights or engine states, for example speed, coolant temperature and so on. The recorded signals are pre-processed by the processing- and control unit 2 and fed via interfaces 3x, 3y, 3z to the means 4 for acting upon the terminal. These means 4 can consist of a loudspeaker 4x, a display 4y or a vibration element 4z. These means 4 for acting upon the terminal form part of the terminal so that the terminals are essentially functionally converted for the acoustic, optical or mechanical signalling of the warning signals.

The invention is not limited to the exemplary embodiment described in the foregoing. Rather, a number of variants are conceivable which utilize the features of the invention, albeit in a basically different type of embodiment.

1. A method of signalling traffic-relevant status information (5), in particular warning signals, to road users, characterised in that existing terminals, in particular mobile telephone, audio device, computer, are used for acoustic and/or optical and/or mechanical signalling, during which time the normal function of the terminal is suppressed.

2. A system for implementing the method according to claim 1, characterised by
means (1) for recording the status information (5)
a processing- and control unit (2) which is connected at its input to the means (1) for recording the status information (5) and
means (4) for acting upon the terminal, which are connected at their input to the processing- and control unit (2).

3. A system according to claim 2, characterised by transmission means for signalling the status information (5) to at least one central station, in particular a weather service, disaster control service.

4. A system according to one of claims 2 or 3, characterised in that the means (1) for recording the status information (5) have the form of a sensor (1a, 1b, 1c) for acoustic and/or optical and/or environmental and/or engine function- and/or body function signals.

5. A system according to one of claims 2 to 4, characterised in that the processing- and control unit (2) comprises
input-end interfaces and/or signal converters,
means for signal processing,
optionally storage means and
optionally selection means.

6. A system according to one of claims 2 to 5, characterised in that the means (4) for acting upon the terminal have the form of a loudspeaker (4x) and/or display (4y) and/or vibration element (4z).

7. A system according to claim 6, characterised in that the means (4) for acting upon the terminal comprise return—transmission elements for transmitting information, in particular terminal on/off information, to the processing—and control unit (2).

8. A system wherein the terminal is a mobile telephone according to claim 6 or 7, characterised in that the means (4) for acting upon the mobile telephone comprise a speech memory for automatic announcements which is connected at its input to the processing- and control unit (2) and at its output to the loudspeaker (4x) of the mobile telephone.
